(19) United States
(12) Patent Application Publication
(10) Pub. No.: US 2026/0246198 A1
(43) Pub. Date: Aug. 20, 2026

(54) ELECTRICAL PLUG CONNECTOR DESIGNED TO BE FAIL-SAFE FOR REDUNDANT LINES

(71) Applicant: ZF FRIEDRICHSHAFEN AG, Friedrichshafen (DE)

(72) Inventors: Ingo BECKER, LINNICH (DE); Bernd OLDEMEYER, Haltern am See (DE)

(21) Appl. No.: 19/161,273

(22) PCT Filed: Mar. 8, 2024
(86) PCT No.: PCT/EP2024/056186

§ 371 Date: Sep. 1, 2025

(30) Foreign Application Priority Data
Mar. 15, 2023 (DE) 10 2023 202 346.6

(51) Int. Cl. H01R 13/533; H01R 13/52

(52) U.S. Cl. CPC H01R 13/533; H01R 13/52; H01R 2201/26

(57) ABSTRACT

A plug connector for a fail-safe cable includes a socket and a plug. The fail-safe cable includes at least two parallel lines each having at least one wire. The socket and the plug can be plugged to the socket and has respective plugging contacts for the at least one wire. The plug connector has a respective connector portion for the at least two parallel lines, said respective connector portion being assigned solely to a relevant line. Each respective connector portion has a socket portion of the socket and a plug portion of the plug, said plug portion being able to be plugged into the socket portion. At least a first of the respective connector portions is configured to be more robust against a potential fault source than a second of the respective connector portions.

### CROSS REFERENCE TO RELATED APPLICATIONS

This application is a U.S. National Phase application under 35 U.S.C. § 371 of International Application No. PCT/EP2024/056186, filed on Mar. 8, 2024, and claims benefit to German Patent Application No. DE 10 2023 202 346.6, filed on Mar. 15, 2023. The International Application was published in German on Sep. 19, 2024 as WO 2024/188856 Al under PCT Article 21(2).

### FIELD

The disclosure relates to a plug connector.

### BACKGROUND

Plug connectors are known from practical experience and have a plug and a socket. They are used for (electrically) interconnecting or disconnecting a cable, in particular an electrical cable, or relevant portions of the cable (one comprising the socket, one comprising the plug). Depending on where they are used, for example in a motor vehicle, plug connectors of this type may be exposed to a series of potential fault sources, for example the ingress of water or grime into the plug connector (between the socket and the plug), full or partial separation of the plug and socket from one another due to e.g., shaking, vibrations, pulling on the plug connector, etc. It is desirable to detect faults or failures in the plug connector (electrical short circuit/breaks) caused by such fault sources as early as possible.

A fail-safe cable comprises at least two lines which run in parallel in the cable or as part of the cable and which are configured to be redundant in relation to one another. Often, however, such cables are connected by means of a single plug connector.

When just one of the lines fails owing to the aforementioned fault sources (faults in the plug connector affecting just one line), the cable can still fulfill its purpose as the second line is then still intact. It is merely the redundancy that is no longer provided. A system using the cable then continues to function with the single line, but the redundancy should be restored as quickly as possible.

### SUMMARY

In an embodiment, the present disclosure provides a plug connector for a fail-safe cable. The fail-safe cable comprises at least two parallel lines each having at least one wire. The plug connector includes a socket and a plug which can be plugged to the socket and has respective plugging contacts for the at least one wire. The plug connector has a respective connector portion for the at least two parallel lines, said respective connector portion being assigned solely to a relevant line. Each respective connector portion has a socket portion of the socket and a plug portion of the plug, said plug portion being able to be plugged into the socket portion. At least a first of the respective connector portions is configured to be more robust against a potential fault source than a second of the respective connector portions.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a plug connector according to the prior art;

FIG. 2 shows a plug connector having isolated connector portions, different materials of the plugging contacts, and a different plugging force, according to embodiments of the present disclosure;

FIG. 3 shows the plug connector from FIG. 2, additionally with different insulation of the plugging contacts for the ingress of water, according to embodiments of the present disclosure;

FIG. 4 shows the plug connector from FIG. 3, additionally with a different plugging overlap of the plugging contacts, according to embodiments of the present disclosure;

FIG. 5 shows the plug connector from FIG. 4, additionally with a different housing overlap, according to embodiments of the present disclosure; and

FIG. 6 shows a plug connector comprising a holding element and a plugging contact integrated therein, according to embodiments of the present disclosure.

### DETAILED DESCRIPTION

Embodiments of the present disclosure provide an improved plug connector for a fail-safe cable.

The plug connector is used or configured for a fail-safe cable, as has been described above. It is thus used for being functionally attached to said cable as a plug connector, in order to be able to interconnect or separate portions of the cable. In this regard, the disclosure is based on or may require the following cable.

To render the cable fail-safe (in particular to provide redundancy), the cable comprises at least two parallel lines. Each of the lines comprises at least one wire. The wire is in particular an electrical wire but could also be a pneumatic, hydraulic, optical, or other wire.

When the plug connector is plugged (the plugged state), wires of the portions are interconnected, in particular each in a one-to-one manner.

The cable is thus in particular an electrical cable but can also be a pneumatic, hydraulic, optical, or other cable, in particular also a cable that combines different wires in one cable (electrical and pneumatic, etc.).

In particular, the plug connector is configured solely for a redundant cable or a cable with multiple redundancy. This cable comprises in particular at least two lines that are redundant in relation to one another. The line itself is in particular a single-wire, twin-wire, or three-wire line. A cable of this kind is then assigned its own plug connector, i.e., in a one-to-one manner.

The plug connector comprises a socket. The plug connector also comprises a plug that belongs/fits to the socket, namely that can be plugged to, in particular into, the socket. The socket and plug have respective plugging contacts for the wires, namely in order to connect the wires when the socket and plug are plugged together and to disconnect the wires when the socket and plug are unplugged. Depending on the wires, the associated plugging contacts are also configured to be electrical, pneumatic, etc. Here, “plugging contact” should be construed in a broad manner and need not actually relate to a plugging operation. The decisive factor is a mutual connection at least in the plugged state (or holding state as applicable; see below).

The plug connector has a respective connector portion for at least two of the lines, in particular for a plurality or all of the lines. At least two of the connector portions are each assigned solely to one of said two lines. In particular, this also applies to the case of a plurality or all of the lines. In other words, each of the thus assigned lines has its own connector portion associated with it alone.

Each of these connector portions has a socket portion of the socket and a plug portion of the plug, with the plugging (or unplugging) of the socket and plug inevitably leading to the plugging or connecting (or unplugging and disconnecting) of the socket portion and plug portion.

At least a first of the connector portions is configured to be more robust against a potential fault source than a second of the connector portions.

The “line” is in particular a merely logical/imaginary/assigned subgroup of wires forming each line. In particular, the at least two of the lines are redundant in relation to one another; in particular, these are the same lines as those which may be configured redundantly inside the cable. Accordingly, the first and second connector portions of each line can then in particular also be considered redundant in relation to one another.

Here, the terms “socket/plug” should be construed in a broad manner and have been selected solely for the purpose of aiding the explanation. However, the socket can also comprise a socket part (e.g., electrical bushes) and a plug part (pins that fit with the bushes); the plug can then accordingly comprise a plug part and a socket part. In this regard, for the purpose of the disclosure it is irrelevant which parts of the plug and socket are plugged into one another and how.

The plug and socket have a plugging direction in which they are plugged into one another (plugged state), the plug and socket being disconnected from one another (unplugged state) in the opposite direction to said plugging direction.

The connector portions are concentrated in particular in a transverse plane to the plugging direction. In other words, different connector portions are thus located in particular next to one another in said cross-sectional plane, for example distributed in a row or in a planar manner, for example in the manner of a chessboard pattern.

In accordance with an embodiment, the disclosure is based on the following observations from practical experience. Modern motor vehicle steering systems may require a high safety integrity level. In particular, therefore, design measures such as redundant subcomponents (e.g., two of each) and redundant signal paths or redundant function paths (lines) are needed so that an isolated fault in one of the paths/routes/lines leaves the other second redundant line in operation.

Here, “motor vehicle” should be construed in a broad manner and can include any kind of ground vehicle, aircraft, or sea-going vessel. In particular, however, it means ground vehicles, in particular passenger cars and trucks.

Contact faults (in particular electrical contact faults) in plug connectors, for example electrical breaks or short circuits as a result of dirt, aging effects, tampering, etc., in a steering system have to be detected at an early stage, in particular if the system is affected by a loss of assist.

As a result of a first or isolated fault in a redundant system, the driver (user of the steering system) is alerted (of the loss of redundancy), but the system still remains in a safe operating state (owing to the redundant component that is still intact). The vehicle can, for example, be stopped safely and the redundancy restored as quickly as possible.

However, in the event of a fault or a fault source, e.g., ingress of water within a steering system, a plug connector involved in the steering could become flooded/wet/damp, meaning that the entire redundant signal path (all the redundant lines of the cable) could be destroyed or fail at the same time. In a case such as this, it would not be possible to alert the driver. In the worst-case scenario, the result would be the sudden failure of the steering system or steering assist. It is imperative to prevent this.

Embodiments of the disclosure are based on the notion of creating fault detection and fault prevention or corresponding methods in a fail-safe connection system/plug connector, as follows. Use is made of the existing redundant signal and power paths (lines) to redundant subcomponents of the steering system, for example to sensors, etc. The fault detection and prevention uncovers short circuits and breaks of plugging contacts over the course of the lines (which are combined physically or logically in a cable), as well as the detection of an intact separated plug connector or one that is intact but in the process of separating. To achieve this, two or more redundant signal paths (lines and their connection by the single plug connector) are constructed such that a fault detection path includes regions within the connection system, i.e., the plug connector. These regions react to the fault sources/disturbances, such as short circuits or breaks resulting from dirt, corrosion, or other environmental influences such as vibrations or thermal loads.

Structural measures on the plug connector ensure that the reaction to the fault source within the plug connector is non-uniform, the expectation being that one connector portion fails more quickly while the other holds out. This creates a time gap in which, for example, the driver can be informed that the redundancy has failed while functionality is maintained.

In particular, this results in a multifunctional fail-safe connection system (plug connector) for automotive steering applications. It is structurally ensured that one connector portion is configured to be more robust than a second connector portion against a potential fault source. As a result, in the event of loading from influences leading to a potential fault, the following occurs. The more robust connector portion is expected to withstand the fault source for a longer period of time than the less robust connector portion, meaning that the less robust connector portion should fail sooner than the more robust connector portion. By way of example, this allows a driver to be alerted, in the manner described above, that the redundancy has been lost but that the functionality of the line leading to the more robust connector portion is maintained. Thus, there is enough time, for example, to bring a vehicle into a safe driving state, locate and eliminate the fault source, and restore the redundancy in the system without the more robustly connected line failing, and a system using this line continues to remain fully functional (apart from the redundancy).

According to embodiments of the disclosure, therefore, a fail-safe connection system of the plug connector, in particular a single plug connector, is produced. The second connector portion constitutes a “redundancy element” in relation to the first connector portion, which is intentionally formed to be more resistant to failures. In other words, the second connector portion is intentionally dimensioned to have a higher likelihood or speed of failure in the face of a particular fault source. Thus, when the fault source arises, the second connector portion is intentionally caused to fail sooner so that an alert can be generated in the system while functionality is maintained, at least for the amount of time in which the functionality of the first connector portion is maintained.

According to embodiments of the disclosure, therefore, a diagnosable plugging system which reacts to fault mechanisms as a result of structural measures is produced.

In a preferred embodiment, the fault source is a short circuit between the plugging contacts of the plug connector owing to the ingress of liquid and/or grime into the plug connector. Alternatively or additionally, the fault source is a break (open circuit) between the plugging contacts owing to vibration (the plug connector loosening out of the plugged state toward the unplugged state) and/or corrosion and/or dirt. Alternatively or additionally, the fault source is a divergence from an intended plugged state between the plug and socket, i.e., they are not plugged (as developed, conceived, intended, or required for safe functioning of the plug connector), for example they do not fully reach the plugged state, they are undergoing gradual separation (toward the unplugged state), or a plug connector housing is defective (for example a crack that allows water to enter). In this case, the plug connector is structurally aimed at precisely that fault source in order to compensate for the fault source in question in accordance with embodiments of the disclosure when it occurs: intentional earlier failure of the second connector portion and thus the loss of redundancy, but functionality of the first connector portion maintained until a later time. The fault sources again relate to electrical, pneumatic, etc., faults.

In a preferred embodiment, the plug connector has a connector housing. The first connector portion is thus configured to be more robust in that the connector housing has an all-around wall which in each case encircles exactly one connector portion, at least the first connector portion, and isolates it from at least the second connector portion or also further connector portions at least when the plug connector is in the intended plugged state. In other words, a closed chamber is created around or at the connector portion in order to encapsulate the plugging contacts assigned to the connector portion and thus to specially protect them or decouple them from the environment and the processes in the other connector portions. For instance, corrosion processes in the second connector portion cannot have any impact on the first connector portion. In particular, the socket and/or the plug have/has a portion of the wall in the form of a separating wall with respect to the rest of the socket/plug.

In other words, the result is insulation from the impacts of fault sources in different connector portions, resulting in a synergistic effect with further measures according to embodiments of the disclosure, for example materials of different robustness for plugging contacts in different connector portions, since the effects of the measures (which have different effects in the connector portions) are limited to the connector portion in question.

In a preferred embodiment, the first connector portion is configured to be more robust as follows. Its plugging contacts have, at least on a longitudinal portion on the bottom side, better electrical insulation from their surroundings than the plugging contacts of the second connector portion. “On the bottom side” means the portion of the plugging contacts that emerges from a main body/part of the connector housing. The better insulation is achieved, for example, by an insulating sheath or coating of the plugging contacts. In the second connector portion, the plugging contacts are then, for example, not insulated from their surroundings at all or are insulated therefrom by a less robust sheath or coating. This embodiment in particular provides protection against a fault source in the form of a short circuit owing to the ingress of liquids or grime.

In other words, in the first connector portion the plugging contacts are better electrically insulated from the surroundings, at least on a longitudinal portion on the bottom side, than the plugging contacts of the second connector portion. In this case, the longitudinal portion is in particular selected such that it is exposed to the fault source in both connector portions when the plug connector is in an intended assembly state, installation set-up, etc., for example because water or grime could accumulate in this region of the connector portion owing to gravity.

In a preferred embodiment, the first connector portion is configured to be more robust against contamination and/or oxidation in that its plugging contacts comprise, or consist of or are coated with, a material that is more suitable in relation to the fault source than those of the second connector portion. In this case too, a corresponding configuration is also implemented in particular where the fault source is potentially likely. In particular, for example, electrical plugging contacts of the first connector portion are made of gold or are gold-plated, whereas those of the second connector portion are made of a material that is more sensitive compared with the first connector portion, for example tin, silver, steel, copper, or the like. This can involve the plugging contacts of the relevant plug portion and/or socket portion, as well as just one, a plurality, or all of the connections (interacting plugging contacts in each case) within the connector portions. Fault sources, which can be intercepted in this way, are in particular short circuits owing to the ingress of liquids or grime and open-circuit operation owing to vibration/shocks (loosening), corrosion, or dirt.

In a preferred embodiment, the first connector portion is configured to be more robust in that its plugging contacts have a greater plugging force than the plugging contacts of the second connector portion. For example, a clamping force of plugging receptacles/plugging bushes for plug pins is greater in the first connector portion than in the second. Analogously to the above, this can again involve one, a plurality, or all of the plugging contacts. In this way, fault sources, in particular in the form of open-circuit operation owing to vibration (loosening of the contact between two plugged plugging contacts), can be counteracted.

In a preferred embodiment, the first connector portion is configured to be more robust in that its plugging contacts are configured to have a larger plugging or contact overlap in the plugging direction than those of the second connector portion. In other words, during the plugging or unplugging operation, there is a larger plugging path or a longer overlap between the respective plugging contacts. Therefore, when the plug and socket are unplugged in a smooth operation, the plugging contacts in the first connector portion separate later than those in the second connector portion. In particular, therefore, there is a longer pluggable portion on the relevant plugging contacts in the plug and/or socket. This should be understood in the plugging direction of the plug connector and thus also of the plugging contacts. These embodiments in particular deal with the fault source of the gradual separation of the plug over time, or of defective, incomplete plugging. For example, the plug and socket defectively do not latch together in a plugged end position, or the plug and socket are not fully plugged into one another as intended. Incorrect operation of the plug connector, for example after maintenance, or a defective plug housing (leading to less of a plugging path than intended for the plugging contacts), or a plug connector housing that no longer securely mechanically holds the socket and plug together, for example owing to the failure of a holding means, can also be dealt with in this way.

In a preferred embodiment, the plug connector has a connector housing. The first connector portion is configured to be more robust in that the connector housing therein of the plug connector, i.e. the connector housing of the first connector portion, is configured to have a larger housing overlap in the plugging direction than the connector housing in the region of the second connector portion. Thus, during unplugging (especially in the event of gradual separation), the connector housing opens later in the first connector portion than in the second, i.e., it is impervious for longer. On the other hand, owing to the larger overlap, the connector housing is more robust against environmental influences in the first connector portion than in the second connector. In this way, in particular the fault sources of short circuits or breaks owing to contamination, or the gradual separation of the plug, can be dealt with.

In a preferred embodiment, the plug connector has a holding element that holds or locks the plug and socket in an intended plugged state (in particular the plug is fully plugged into the socket), i.e., prevents any separation. The second connector portion is configured to be less robust in that at least one of the plugging contacts is correlated with the holding element in such a way that in the plugged state said plugging contact is contacted only when the holding element is in an intended holding state. An intended holding state is, for example, the latching of the holding element in a latching position and/or the engagement behind a holding shoulder, etc., by the holding element, etc. In particular, a plugging contact that brings about a power supply through the line is correlated with the holding element. In the non-intended holding state, the contact is then lost and, for example, so too is the power supply through the line. In this way, the fault source whereby the holding element is not in its intended holding state can be dealt with. The second connector portion is configured to be less robust in that even just separation of the holding element, which is not necessarily accompanied by separation of the plug connector or of the plug and socket, causes the plugging contact and thus the connected wires to fail.

The holding state can thus be construed as a plugged state subject to particularly stringent requirements (correctly positioned holding element).

In a preferred embodiment, the plug connector is not configured to be fluid-tight. The ingress of liquid into the plug connector is thus intentionally accepted or even induced. The two connector portions are then configured for the fault case of “liquid ingress”. Thus, in this fault case, failure of the second connector portion may also be intentionally induced so that this fault case does not go undetected and can be reacted to while the first connector portion is still intact.

In a preferred embodiment, the plug connector is intended to be part of a steering system for a motor vehicle. The steering system is in particular an electrical steering system (steer-by-wire) or an Advanced Driver Assistance System (ADAS). Using a plug connector according to embodiments of the disclosure is particularly effective in such steering systems in order to prevent simultaneous double or multiple faults. Instead, as explained above, an alert about the failure of the redundancy can be generated while the functionality of the plug connector/cable/steering system, though no longer redundant, is maintained.

In accordance with an embodiment, the present disclosure provides a cable arrangement including the plug connector according to embodiments of the disclosure and the cable that is connected or is to be connected by the plug connector. In particular, the cable comprises the cable portions that are or can be connected by the plug connector, which thus respectively open into or end in the socket and the plug of the plug connector.

The cable arrangement and at least some of the possible embodiments and the respective advantages have already been explained in substance in connection with the plug connector according to embodiments of the disclosure.

In accordance with an embodiment, the present disclosure provides a steering system for a motor vehicle. The steering system comprises the cable arrangement according to embodiments of the disclosure and thus the cable and the plug connector according to embodiments of the disclosure, which is thus part of the steering system. Therefore, the cable is equipped with the plug connector according to embodiments of the disclosure. The plug connector is attached in the cable and is used to connect or separate said cable by means of the plug connector.

The steering system and at least some of the possible embodiments thereof and the respective advantages have already been explained in substance in connection with the cable arrangement according to embodiments of the disclosure.

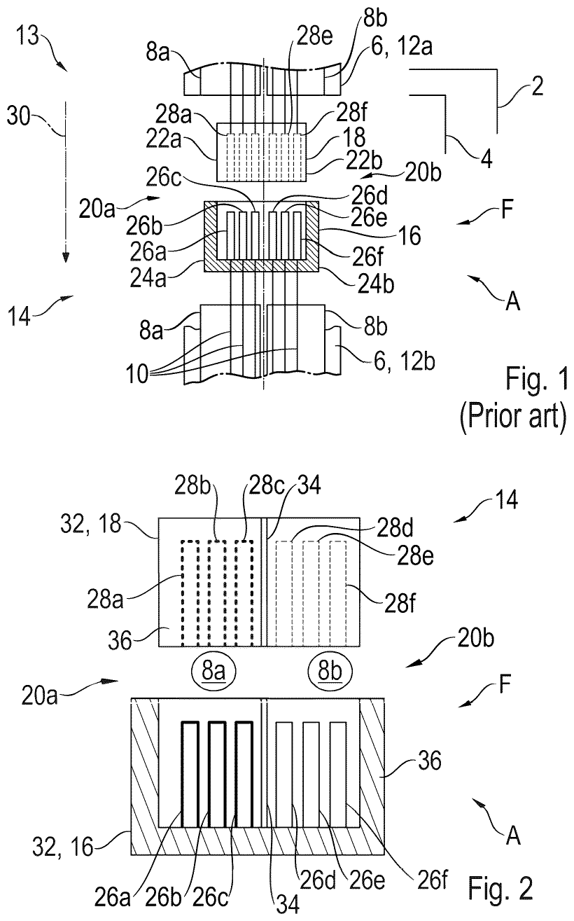

FIG. 1 shows a plug connector, configured according to the prior art, for an electrical steering system 4 (steer-by-wire). It comprises a cable 6. The cable 6 comprises two parallel lines 8a,b which are redundant in relation to one another and thus built identically/in the same way. Each of the lines 8a,b comprises a total of three wires 10, in this case electrical conductors. In the longitudinal direction or the direction of extent, the cable 6 is divided into two cable portions 12a,b, which can be or are connected by means of a plug connector 14. The cable 6 is thus a fail-safe cable or redundant cable. For reasons of clarity, FIG. 1 shows the unplugged state A (plug connector 14 not plugged).

Together, the plug connector 14 and the cable 6 that is connected or is to be connected by the plug connector 14 form a cable arrangement 13.

The plug connector 14 comprises a socket 16 and a plug 18 that can be plugged into the socket 16. For each of the lines 8a,b, the plug connector 14 comprises its own connector portion 20a,b assigned to that line 8a,b alone. The connector portions 20a,b are not necessarily physically/structurally discernible on the plug connector 14 and thus rather constitute “logical subunits” of the plug connector 14. In FIG. 1, therefore, they are indicated by a dashed line.

The connector portion 20a comprises a socket portion 22a and a plug portion 24a. Accordingly, the connector portion 20b comprises a socket portion 22b and a plug portion 24b. These are thus also each assigned solely to the relevant line 8a,b. For each of the wires 10, the socket 16 comprises a corresponding plugging contact 26a-f, in this case plug pins. The plug 18 accordingly comprises plugging contacts 28a-f, in this case plugging receptacles/bushes for the plug pins.

FIG. 1 shows the plug connector 14 in the unplugged state A. The following explanations relate to the plugged state S (not shown; see similar FIG. 6), not the unplugged state A, of said plug connector. In the plugged state S, the plug 18 is plugged fully into the socket 18 in a plugging direction 30.

The connector portions 20a,b are configured to be equally robust against a potential fault source F, in this case water entering (not shown) the plug connector 14 or between the socket 16 and the plug 18.

When the plug connector 14 is subjected to the fault source F (in this case immersion in water), it is assumed that water enters the plug connector 14 and shorts all the plugging contacts 26a-f, 28a-f and thus leads to the two redundant connector portions 20a,b and lines 8a,b failing simultaneously. This constitutes a dangerous situation for a motor vehicle 2 and should be prevented in all cases.

FIG. 1 thus shows a plug connector 14 according to the prior art, comprising two connector portions 20a,b which are not configured to have different levels of robustness against the fault source F.

FIG. 2 shows a plug connector 14 according to embodiments of the disclosure, which replaces the plug connector 14 from FIG. 1 in the vehicle 2. For the sake of clarity, the cable 6 is not shown in more detail here. The plug connection of the cable 6 or of the portions 12a,b is more fail-safe owing to the plug connector 14 according to embodiments of the disclosure and is thus improved, as explained below.

In FIG. 2, the connector portion 20a is configured to be more robust than the connector portion 20b against fault sources F owing to a first measure. This is achieved as follows. A connector housing 32 of the plug connector 14 is shared between the socket 16 and the plug connector 18, i.e., a main body of the socket 16 and the plug 18 together form the connector housing 32. The plug connector 14 or the connector housing 32 or the socket 16 and the plug 18 have a respective separating wall 34. Together with the rest of the connector housing 32, the separating walls 34 each form, in the plugged state S (not shown), an all-around wall 36 around the relevant connector portion 20a,b, each wall encircling or enclosing said connector portion in an isolating manner. In other words, the particular plugging contacts 26a-c and 28a-c together are encased in their entirety. The same applies to the plugging contacts 26d-f and 28d-f. Effects and impacts caused by the fault source F thus occur separately or independently of each other in each connector portion 20a,b.

The actual difference here results from a second measure, which nonetheless interacts synergistically with the first. The plugging contacts 26a-c and 28a-c are made of a more robust material, namely gold, or are gold-plated, compared with the plugging contacts 26d-f and 28d-f, which are made, for example, of tin, silver, steel, copper, or the like.

Moreover, as a third measure, the plugging force in these plugging contacts 26a-c and 28a-c is increased compared with the other plugging contacts 26d-f and 28d-f in that the plugging receptacles 28a-c have a higher spring force than the plugging receptacles 28d-f.

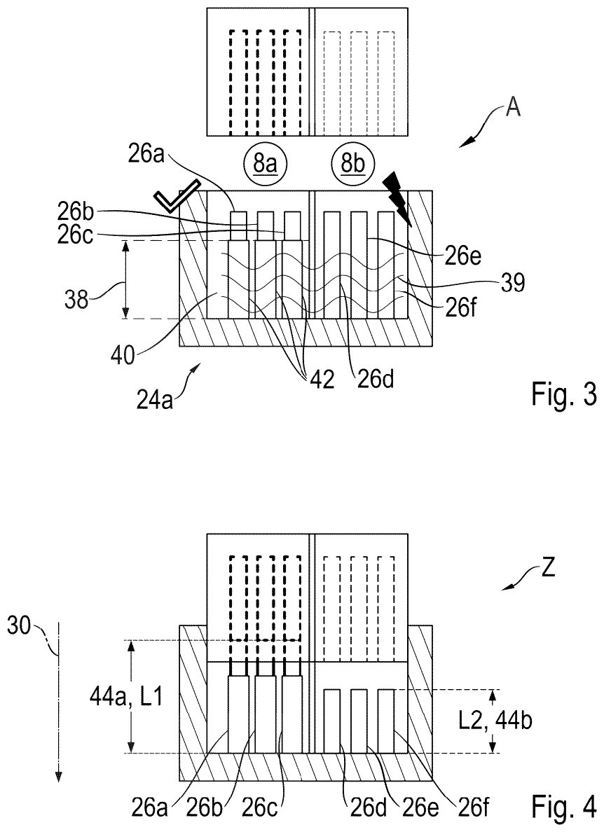

FIG. 3 shows the plug connector 14 from FIG. 2 but in this case equipped with a fourth measure. Here, the plugging contacts 26a-c are additionally electrically insulated from their surroundings 40 (internal chamber of the plug portion 24a in the plugged state S) on a longitudinal portion 38 on the bottom side, whereas the plugging contacts 26d-f are not. This is achieved by encasing insulation 42. The plugging contacts 28a-c and 26a-c are thus respectively insulated from one another. “On the bottom side” means that the longitudinal portions begin at the site where the plugging contacts 26a-c emerge from the “bottom” of the socket 16 (connector housing 32). FIG. 3 also shows the unplugged state A to illustrate the described measures more clearly. However, the measures of FIGS. 2 and 3 provide the protective effect in the plugged state S (not shown in each case), as follows.

A short circuit between the plugging contacts 26a-f, 28a-f, for example owing to the ingress of water 39, as indicated by symbols in FIG. 3, is the fault source F under consideration in this case. Short circuits in the steering system 4 or cable 6 can be detected as follows. Short circuits result from contamination or the ingress of liquid or other conductive material/particles in the plug connector 14 (space between the socket 16 and the plug 18).

The connection system according to embodiments of the disclosure is now conceived such that the connection of the first line 8a in the plugged state S is separated from the line 8b owing to the separating wall 34. The line 8a is therefore conceived as a robust connection that separates all the signal path connections from one another using insulation (insulation process as per FIG. 3: insulation 42).

The line 8b, however, is conceived as a less robust connection that allows for an area where the plugging contacts 26d-f and 28d-f can potentially interact (short circuit). In this regard, the line 8a also comprises a plugging contact material (plugging contacts 28a-c, 26a-c) which is more robust against external influences and less sensitive to corrosion (gold). The line 8b, however, is a less robust connection that includes plugging contact material made of a more sensitive material, for example tin, silver, steel, copper, or the like, for the plugging contacts 26d-f and 28d-f.

If ingress of water 39 were to happen, a short circuit would occur in the connector portion 20b owing to the lack of insulation; this would be detected in the steering system 4 in the line 8b, and so a driver of the motor vehicle 2 could be alerted of the failure of the line 8b (loss of redundancy). However, the line 8a which is more robust against this fault source F remains intact, meaning that the steering system 4, though no longer redundant, remains functional.

According to FIGS. 2 and 3, detection of breaks is also possible. A break is a consequence of a weakening of the contact, for example owing to vibrations, corrosion (plugging contacts 26a-f, 28a-f), or contamination (electrically insulating means/particles between the plugging contacts 26a-f and 28a-f), etc. The plug connector 14 is conceived such that the connection of the line 8a is separated from that of the line 8b (separating wall 34; see above). In addition, owing to the use of the more robust material (gold), the line 8a is more robust against the fault source of corrosion/oxidation/contamination than the line 8b (which, for example, is made of tin, silver, steel, copper, or the like). In the event of loading owing to contamination or corrosion/oxidation, the simple material in the line 8b degrades sooner, causes a break in the contact/line, and triggers the above-mentioned detection/alert. The more robust material in line 8a, on the other hand, maintains contact such that the line 8a remains electrically conductively intact.

Moreover, the fault source of vibration/shaking can thus be compensated for. In the event of vibrational effects, the secure electrical connection between the plugging contacts 26a-c and 28a-c, i.e., between the plug pin and the plugging receptacle, is in each case sturdier and more robust owing to the increased plugging force, meaning that here too the electrical connection in line 8a is securely retained. Owing to the weaker, less robust outer coating, however, contact between the corresponding plug pins and plugging receptacles is broken in line 8b since they become loose. This fault can be detected too, and the driver of the motor vehicle 2 can be alerted, with the line 8a remaining intact when the line 8b fails.

FIG. 4 shows an additional fifth measure. Here, the plugging contacts 26a-c are configured to be longer than the plugging contacts 26d-f in the plugging direction 30, i.e., they have a length L1 that is greater than the length L2. In the plugged state S (not shown), therefore, a contact overlap 44a of length L1 in the line 8a is greater than the contact overlap 44b of length L2 in the line 8b.

In this way, loosening in the plug connector 14 can be detected, as follows. Loosening of the plug connector 14 is a consequence of the plug 18 leaving the plugged state S in the socket 16 and moving away toward the unplugged state A. FIG. 4 shows an intermediate position Z therebetween. The intermediate position Z can also be a consequence of the plug connector 14 being incompletely assembled, for example after maintenance or incorrect operation (plugged state S never reached). The connector portion 20a or line 8a is configured to be more robust in that the plugging contacts 26a-c, 28a-c have a larger contact overlap L1, as described. In the intermediate position Z, therefore, the contacts 26d-f, 28d-f in the line 8b have already lost their contact, whereas this contact is still maintained in the line 8a. In the event of gradual separation of the plugged state S toward the unplugged state A via the intermediate position Z, the line 8b is thus affected first. As soon as the line 8b is broken, the driver of the motor vehicle 2 can be alerted again, with the line 8a still having electrical contact and thus being intact.

The separation can, for example, be caused by a weak connection between the socket 16 and the plug 18, which is no longer sufficiently held by the mechanical connector housing 32 or a defective connector housing 32. This will lead to separation/gradual movement toward the unplugged state A over time.

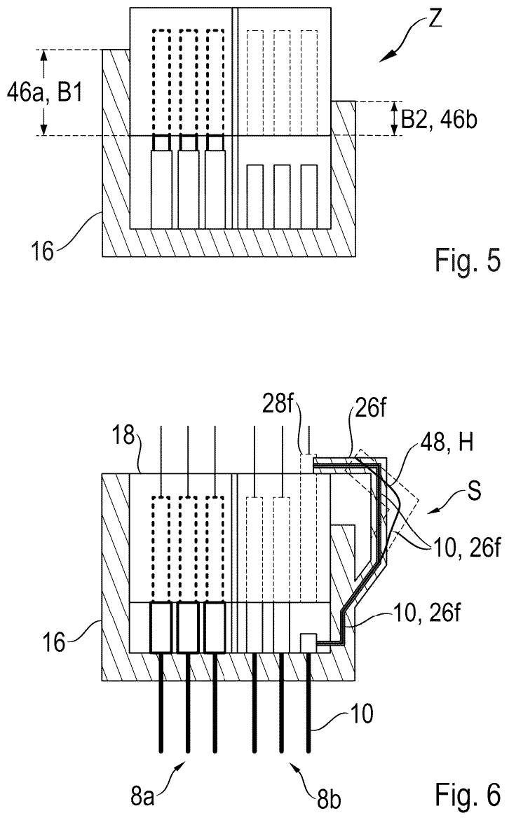

FIG. 5 shows an additional sixth measure for configuring the connector portion 20a to be more robust than the connector portion 20b. Here, the former has a larger housing overlap 46a, namely via the region B1 instead of the smaller region B2 as the housing overlap 46b. This also leads to better prevention of breaks or short circuits in the connector portion 20a than in the connector portion 20b.

Breaks or short circuits are an effect of the fault source F “dirt containing conductive/non-conductive material”. Here, the larger housing overlap 46a is achieved by a “higher” connector housing 32 at the socket 16 in the connector portion 20a, which thus engages over or covers/encompasses the plug 18 to a greater extent in the plugging direction 30 when in the plugged state S. This prevents, in the event of gradual separation of the plug connector 14 (the intermediate position Z is shown here again), starting from the plugged state S. This measure reduces the risk of conductive or non-conductive particles entering the surroundings 40 of the plugging contacts 26a-c, 28a-c, accumulating therebetween, and causing short circuits or breaks, or reduces the speed at which they do so. Here too, therefore, the line 8b will again fail sooner than the line 8a (as it gets contaminated more quickly) after a certain amount of time owing to such effects, thereby allowing the driver to be warned while the steering system 4 functions intact owing to the line 8a.

FIG. 6 shows a seventh measure. Here, the plug connector 14 has a holding element 48. This holding element holds the plug 18 and socket 16 in the plugged state S shown. Here, one of the wires 10 (the right-hand wire in FIG. 6) of the line 8b is correlated with the holding element 48 in that the wire 10 or the associated plugging contact 26f is guided through or integrated in the holding element 48. Here, the holding element 48 is a holding clip which interlockingly engages behind the plug 18 in the holding state H.

In the plugged state S, the plugging contact 26f contacts the plugging contact 28f only when the holding element 48 is in the intended holding state H shown in FIG. 6. In this case, the plugging contacts 26f, 28f are degraded to touch contacts as no actual plugging takes place here. However, to aid understanding in relation to a plug connector 14, the same terminology will still be used. Incomplete plugging (or engagement) is then detected as follows.

Here, incomplete plugging, as the fault source F, results from a plug connector 14 fully separating during operation, from the plug connector 14 not being fully assembled during maintenance, or from incorrect operation, and can occur despite the holding element 48 integrated on the plug connector 14. In other words, the plug connector 14 is now conceived such that one of the electrical connections in the line 8b (right-hand wire 10 in FIG. 6; here the power supply wire thereof) is guided through the holding element 48 (in this case the clip). The holding element 48 holds the plug 18 in the socket 16 when properly assembled, i.e., when in the holding state H. If the holding state H is not assumed (shown in dashed lines in the drawings), the plugging contact 26f no longer abuts the plugging contact 28f, and the electrical connection in the wire 10 (here the power supply) is broken. This can also be detected immediately after the plug connector 14 is incorrectly assembled.

As a result, the connector portion 20a here is configured to be more robust in that the connector portion is configured to be less robust against a fault source F in relation to the holding element 48.

Generally, the plug connector 14 is not configured to be watertight, and it can be assumed that the ingress of water will lead to the complete loss of all the signal paths (on all the wires 10) after a particular amount of time. According to embodiments of the disclosure, this break in the signal paths is divided into the break in the connector portion 20a and in the connector portion 20b, the former being expected at a later time owing to the aforementioned structural measures. A time of failure of the two lines 8a,b is thus temporally “stretched”, i.e., spread over different times, for one and the same fault source F. The intervening time is sufficient for reporting the failure of the line 8b while the line 8a continues to function, thereby allowing a driver of the motor vehicle 4 to be alerted while the steering system 4 continues to operate.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

2 Motor vehicle
4 Steering system
6 Cable
8a,b Line
10 Wire
12a,b Portion (cable)
13 Cable arrangement
14 Plug connector
16 Socket
18 Plug
20a,b Connector portion
22a,b Socket portion
24a,b Plug portion
26a-f Plugging contact (socket, plug pin)
28a-f Plugging contact (plug, plugging receptacle)
30 Plugging direction
32 Connector housing
34 Separating wall
36 Wall
38 Longitudinal portion
39 Water
40 Surroundings
42 Insulation
44a,b Contact overlap
46a,b Housing overlap
48 Holding element
F Fault source
A Unplugged state
S Plugged state
L1,2 Length
Z Intermediate position
B1,2 Region
H Holding state

1. A plug connector for a fail-safe cable, wherein the fail-safe cable comprises at least two parallel lines each having at least one wire, comprising:
a socket and a plug which can be plugged to the socket and has respective plugging contacts for the at least one wire,
wherein the plug connector has a respective connector portion for the at least two parallel lines, said respective connector portion being assigned solely to a relevant line,
wherein each respective connector portion has a socket portion of the socket and a plug portion of the plug, said plug portion being able to be plugged into the socket portion,
wherein at least a first of the respective connector portions is configured to be more robust against a potential fault source than a second of the respective connector portions.

2. The plug connector according to claim 1, wherein the potential fault source is a short circuit between the respective plugging contacts of the plug connector owing to an ingress of liquids and/or grime into the plug connector and/or a break between the respective plugging contacts owing to vibration and/or corrosion and/or dirt and/or a divergence from an intended plugged state between the plug and socket.

3. The plug connector according to claim 1, wherein the plug connector has a connector housing, and the first connector portion is configured to be more robust in that the connector housing has an all-around wall that isolates the first connector portion from at least the second connector portion at least when in a plugged state.

4. The plug connector according to claim 1, wherein the first connector portion is configured to be more robust in that plugging contacts of the first connector portion have, at least on a longitudinal portion on a bottom side, better electrical insulation from their surroundings than the plugging contacts of the second connector portion.

5. The plug connector according to claim 1, wherein the first connector portion is configured to be more robust in that plugging contacts of the first connector portion comprise a more robust material than those of the second connector portion.

6. The plug connector according to claim 1, wherein the first connector portion is configured to be more robust in that plugging contacts of the first connector portion have a greater plugging force than those of the second connector portion.

7. The plug connector according to claim 1, wherein the first connector portion is configured to be more robust in that plugging contacts of the first connector portion are configured to have a larger contact overlap in a plugging direction than those of the second connector portion.

8. The plug connector according to claim 1, wherein the plug connector has a connector housing, and the first connector portion is configured to be more robust in that the connector housing of the first connector portion is configured to have greater housing overlap in the plugging direction than that of the second connector portion.

9. The plug connector according to claim 1, wherein the plug connector has a holding element that holds the plug and the socket a plugged state, and the second connector portion is configured to be less robust in that at least one of the respective plugging contacts is correlated with the holding element in such a way that in the plugged state said respective plugging contact is contacted only when the holding element is in an intended holding state.

10. The plug connector according to claim 1, wherein the plug connector is not configured to be watertight.

11. The plug connector according to claim 1, wherein the plug connector is intended to be part of a steering system for a motor vehicle.

12. A cable arrangement comprising the plug connector according to claim 1 and comprising the fail-safe cable to be connected by the plug connector.

13. A steering system for a motor vehicle, comprising the cable arrangement according to claim 12.
